(19) United States
(12) Patent Application Publication
(10) Pub. No.: US 2020/0013158 A1
(43) Pub. Date: Jan. 9, 2020

(54) LEARNING APPARATUS, LEARNING METHOD, AND LEARNING PROGRAM

(71) Applicant: Konica Minolta, Inc., Tokyo (JP)

(72) Inventors: Shinichi ASAI, Tokyo (JP); Daisuke GENDA, Kawasaki-shi (JP)

(21) Appl. No.: 16/434,346

(22) Filed: Jun. 7, 2019

(30) Foreign Application Priority Data
Jul. 3, 2018 (JP) 2018-126639

(51) Int. Cl. G06T 7/00; H04N 1/00

(52) U.S. Cl. CPC G06T 7/0002; H04N 1/00005; G06T 2207/30168; G06T 2207/20081; G06T 2207/30176

(57) ABSTRACT

A learning apparatus includes an image defect detector that detects an image defect on a sheet on which an image has been formed, a likelihood calculator that calculates a likelihood that an image forming member associated with the image formation is a generation factor of the image defect, a predictor that predicts a change in the image defect generated by the image forming member as a generation factor; and a learning unit that causes the predictor to perform learning using the detected image defect as learning data, wherein the learning unit changes, according to the likelihood, a learning mode of the image defect to be used as the learning data.

### CROSS REFERENCE TO RELATED APPLICATIONS

The present invention claims priority under 35 U.S.C. § 119 to Japanese Application No. 2018-126639, filed Jul. 3, 2018, the entire content of which is incorporated herein by reference.

### BACKGROUND

### Technological Field

The present invention relates to a learning apparatus, a learning method, and a learning program.

### Description of the Related Art

Generally, an image forming apparatus (for example, a printer, a copier, and a facsimile machine) utilizing an electrophotographic process technique forms an electrostatic latent image by irradiating (exposing) an electrified photosensitive drum (image bearing member) with laser light based on image data. Then, the image forming apparatus visualizes the electrostatic latent image as a toner image by supplying toner from a developing device to the photosensitive drum bearing the electrostatic latent image formed thereon. Further, the image forming apparatus forms the toner image on a paper sheet by transferring the toner image directly or indirectly onto the paper sheet and then fixing the toner image by heating and pressurizing the paper sheet at a fixing nip.

In such an image forming apparatus, there is a model that, regularly or in accordance with the occurrence of an image defect (also referred to as a defected image, abnormal image, or the like), performs processing of, in addition to a normal use state (hereinafter referred to as a normal mode), a diagnosis mode for diagnosing failure, malfunction, durability, and the like of various image forming members (hereinafter referred to as “component units”) related to image formation inside the apparatus. In this diagnosis mode, for example, based on various data of aspects (such as type and feature value) of an image defect and past usage history (number of printed sheets, time when each component unit has been replaced, etc.) in the image forming apparatus, failure diagnosis of component units, prediction of replacement timing of the component units, and the like are performed.

In this regard, for example, JP 2014-16437 A describes a technique of determining a failure location by analyzing feature values of image defects in time series.

Generally, in the diagnosis mode, when performing failure diagnosis of a component unit or predicting the replacement timing, a component serving as a generation factor of an image defect is identified and the replacement timing of the component unit (so-called remaining lifetime) is predicted, from an image feature value of the detected image defect, the use condition of the component unit, and the like.

However, generally, in the diagnosis mode, it is not always possible to identify a component unit serving as a generation factor of an image defect with high certainty, and in particular, when a plurality of candidate component units are identified, the accuracy of prediction of replacement timing of the component units is poor. For example, in the diagnosis mode, when an image streak is detected as an image defect, a photosensitive unit may be identified as the generation factor of the image streak with 100% likelihood (or probability) in some cases, and a photosensitive unit and a band electrode unit can be also identified as generation factors of the image streak with 50% likelihood. For this reason, conventionally, it has been required to improve the accuracy of identification of the generation factor of the image defect in the diagnosis mode, and also the accuracy of lifetime prediction of the image forming member.

### SUMMARY

An object of the present invention is to provide a learning apparatus, a learning method, and a learning program capable of improving the accuracy of lifetime prediction of an image forming member.

To achieve the abovementioned object, according to an aspect of the present invention, a learning apparatus reflecting one aspect of the present invention comprises an image defect detector that detects an image defect on a sheet on which an image has been formed, a likelihood calculator that calculates a likelihood that an image forming member associated with the image formation is a generation factor of the image defect, a predictor that predicts a change in the image defect generated by the image forming member as a generation factor, and a learning unit that causes the predictor to perform learning using the detected image defect as learning data, wherein the learning unit changes, according to the likelihood, a learning mode of the image defect to be used as the learning data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 schematically illustrates an overall configuration of an image quality inspection system according to an embodiment;

FIG. 2 is a block diagram illustrating a main part of a control system in the image quality inspection system of FIG. 1;

FIG. 3 is a flowchart showing an example of an outline of processing of an inspection job and a mode of transition to a diagnosis mode;

FIG. 4 is a graph for explaining results of learning a prediction model and predicting the date of end of lifetime of a component unit;

FIG. 5 is a characteristic graph illustrating an example of a relationship between examples of feature values and expression regions of component units serving as generation factors;

FIG. 6 is a flowchart for explaining a method of setting weights of machine learning data in the embodiment; and

FIG. 7 is a flowchart showing the flow of processing in the diagnosis mode.

### DETAILED DESCRIPTION OF EMBODIMENTS

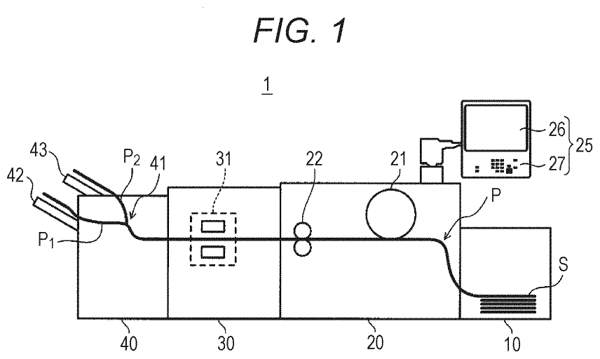

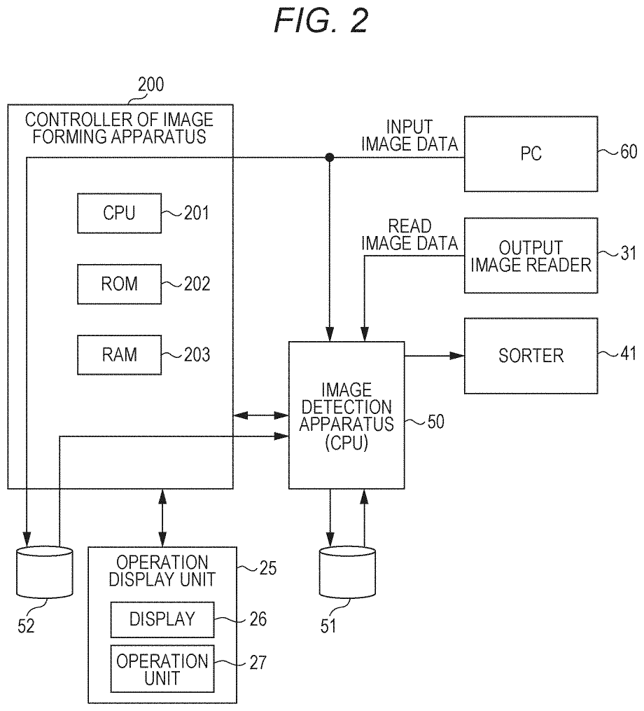

Hereinafter, one or more embodiments of the present invention will be described with reference to the drawings. However, the scope of the invention is not limited to the disclosed embodiments. FIG. 1 schematically illustrates an overall configuration of an image quality inspection system 1 according to an embodiment of the present invention. FIG. 2 is a diagram illustrating a main part of a control system for describing, for example, the flow of signals between apparatuses constituting the image quality inspection system 1 of the present embodiment.

After the image quality inspection system 1 shown in FIG. 1 and FIG. 2 forms (outputs) an image on a sheet S by an image forming apparatus 20, the image quality inspection system 1 reads the image on the sheet S, and based on the reading result, inspects whether the quality of the output image is good or bad (whether an image defect has occurred). In addition, the image quality inspection system 1 transitions to a diagnosis mode, in which diagnosis of a failure status of a component unit (image forming member) related to image formation in the image forming apparatus 20, prediction of replacement timing of the component unit, and the like are performed, regularly or when an image defect occurs during execution of a normal print job. The processing of the diagnosis mode will be described later.

As illustrated in FIG. 1, the image quality inspection system 1 includes the image forming apparatus 20 that forms an image based on input image data on the sheet S, a sheet feeding apparatus 10 that feeds the sheet S to the image forming apparatus 20, an image reading apparatus 30 that reads the image on the sheet S discharged from the image forming apparatus 20, and a post-processing apparatus 40 including a plurality of sheet discharge trays (42 and 43).

In the image quality inspection system 1, the sheet feeding apparatus 10, the image forming apparatus 20, the image reading apparatus 30, and the post-processing apparatus 40 are physically connected in this order from the upstream side in the conveyance direction of the sheet S, and thus a conveyance path P of the sheet S extends through the plurality of apparatuses. The conveyance path P is branched by a sorter 41 of the post-processing apparatus 40 into a path P₁ connected to a lower sheet discharge tray 42 and a path P₂ connected to an upper sheet discharge tray 43.

Although the conveyance path P in the image forming apparatus 20 is shown by a single line in FIG. 1 for the sake of simplicity, the actual image forming apparatus 20 is provided with a duplex conveyance path for duplex printing. Further, although two branching paths P₁ and P₂ are provided in the post-processing apparatus 40 in FIG. 1 for the sake of simplicity, more branching paths may be provided according to the number of sheet discharge trays and the like.

The sheet feeding apparatus 10 can store sheets S of various sizes and sheet types. The sheet feeding apparatus 10 includes a sheet feeding roller for feeding the stored (stacked) sheets S one by one, a motor for driving the sheet feeding roller, and the like.

The image forming apparatus 20 includes an image forming unit 21 of an intermediate transfer type utilizing an electrophotographic process technique. That is, the image forming unit 21 transfers toner images of respective colors of yellow (Y), magenta (M), cyan (C), and black (K) formed on photosensitive drums that are not illustrated onto an intermediate transfer belt (not illustrated) through primary transfer such that the toner images of four colors are superposed on one another on the intermediate transfer, then transfers the superposed toner image onto the sheet S through secondary transfer, and thus forms a toner image. A fixing unit 22 that fixes the toner image on the sheet S by heating and pressurizing the sheet S onto which the toner image has been transferred through secondary transfer and which has been conveyed thereto is disposed downstream of the image forming unit 21 in the conveyance direction of the sheet S. Since the image forming unit 21 and the fixing unit 22 have known configurations, detailed illustration thereof is omitted.

Here, the image forming unit 21 includes a plurality of component units (image forming members) for forming an image on the sheet S, and each component unit can be replaced by being detached from a frame or an apparatus body (not illustrated) of the image forming apparatus 20. Examples of the component unit of the image forming unit 21 include, a developing unit in which a developing device, a toner cartridge, and the like are integrated, a photosensitive unit including a photosensitive drum and the like, a charging unit including a band electrode for charging the surface of the photosensitive drum, and a transfer unit including an intermediate transfer belt for transferring an image (toner image) formed on the photosensitive drum onto the sheet S. Among the above, component units other than the transfer unit are provided for each color of Y (yellow), M (magenta), C (cyan), and K (black). Each of these component units of the image forming unit 21 has a known configuration, and illustration and detailed description thereof will be omitted.

An operation display unit 25 is provided on the apparatus body of the image forming apparatus 20. The operation display unit 25 is constituted by, for example, a liquid crystal display (LCD) equipped with a touch panel, and functions as a display 26 and an operation unit 27. The display 26 displays various operation screens, a state of an image, an operation state of each function, and the like in accordance with a display control signal input from a controller 200 that will be described later. The operation unit 27 includes various operation keys (so-called hardware switches) such as a numeric keypad and a start key, receives various input operations by a user, and outputs an operation signal to the controller 200. In addition, the display 26 displays various icons (so-called software switches) selectable by a cursor (pointer) or the like on various screens that will be described later, receives various input operations by the user, and outputs an operation signal to the controller 200 (see FIG. 2).

As illustrated in FIG. 2, the image forming apparatus 20 includes a controller 200 that performs overall control of the image forming apparatus 20. The controller 200 includes a central processing unit (CPU) 201, a read only memory (ROM) 202, a random access memory (RAM) 203, and so forth, and controls operation of the image forming unit 21, the fixing unit 22, and the operation display unit 25 described above, and of other units provided in the image forming apparatus 20. The CPU 201 of the controller 200 reads a program corresponding to the content of processing from the ROM 202, loads the read program on the RAM 203, and dominantly controls the operation of the image forming unit 21, the fixing unit 22, the operation display unit 25, and other blocks in the image forming apparatus 20 in cooperation with the loaded program.

Examples of the other blocks provided in the image forming apparatus 20 include an image processor that performs various corrections such as gradation correction on input image data, a sheet conveyance unit that drives a plurality of conveyance rollers that convey the sheet S, and a communication unit that communicates with an external apparatus through a communication network or the like. Further, the image forming apparatus 20 may have a configuration as a copier for copying a document image onto the sheet S, that is, a configuration including an automatic document feeding device such as an auto document feeder (ADF) and a document image scanning device (scanner).

As illustrated in FIG. 1 and FIG. 2, the image reading apparatus 30 includes an output image reader 31 that optically reads an image (toner image) on the sheet S discharged from the image forming apparatus 20. Specifically, the output image reader 31 optically scans the sheet S, causes reflection light from the sheet S to form an image on a light receiving surface of a charge coupled device (CCD) sensor that is not illustrated, thus reads images on both surfaces of the sheet S, and generates read image data based on the reading results. The read image data generated by the output image reader 31 is input to an image inspection apparatus 50 that will be described later.

As illustrated in FIG. 1 and FIG. 2, the post-processing apparatus 40 includes a conveyance roller that conveys the sheet S whose image has been read by the image reading apparatus 30, the plurality of sheet discharge trays 42 and 43 that discharge the sheet S, and the sorter 41 that switches the discharge destination (conveyance route) of the sheet S. For the sake of simplicity, FIG. 2 exemplifies a configuration provided with the two sheet discharge trays 42 and 43, but the number of sheet discharge trays can be arbitrarily selected, and more sheet discharge trays may be provided. The sorter 41 has a switching gate that switches the discharge destination (conveying route) of the sheet S to either the path P₁ or the path P₂, a drive source such as a solenoid that drives the switching gate, an interface for transmitting and receiving data to and from the image forming apparatus 20 and the image inspection apparatus 50, and so forth.

As illustrated in FIG. 2, the image quality inspection system 1 includes the image inspection apparatus 50 that inspects whether the quality of the output image formed (outputted) on the sheet S based on the read image data generated by the image reading apparatus 30 is good or bad (whether an image defect has occurred or not). The image inspection apparatus 50 includes a hardware processor such as a CPU, a ROM, a data storage 51 that will be described later, and the like, and the CPU reads and executes a program stored in the ROM to execute a job (hereinafter referred to as an inspection job) for checking whether the quality of the output image is good or (whether an image defect has occurred or not) and processing of a diagnosis mode that will be described later.

In the present embodiment, the image inspection apparatus 50 functions as an image defect detector, a likelihood calculator, a predictor, and a learning unit. Among these, the image defect detector performs processing of inspecting whether an image defect has occurred or no in the image from a result of reading the image on the sheet S in the inspection job described above and the diagnosis mode that will be described later. Further, when an image defect occurs, the likelihood calculator identifies a component unit of the image forming apparatus 20 (image forming unit 21) serving as a generation factor of the image defect from a feature value of the image defect and calculates a likelihood (a value representing certainty) that the component unit is a generation factor of the image defect. In addition, the predictor predicts a change in an image defect generated by the identified component unit as a generation factor. More specifically, the predictor learns, for each component unit, a “prediction model” representing the future change of the image defect. Also, the learning unit causes the predictor to learn using the detected image defect as learning data. Details of these units will be described later.

The image inspection apparatus 50 can be physically incorporated in a housing of, for example, the image reading apparatus 30, the post-processing apparatus 40, and the image forming apparatus 20, or configured as an apparatus physically independent of these apparatuses. In the example shown in FIG. 2, the image inspection apparatus 50 is the latter, that is, a physically independent apparatus, and is electrically connected to the controller 200 and the like of the image forming apparatus 20 that will be described later.

Further, As illustrated in FIG. 2, the image quality inspection system 1 includes a personal computer (PC) 60 that outputs input image data and printing conditions (various user set values such as a printing method and the number of copies) as reference data. In the example shown in FIG. 2, the PC 60 supplies the reference data described above to both the image forming apparatus 20 (controller 200) and the image inspection apparatus 50.

Further, as illustrated in FIG. 2, the image quality inspection system 1 includes data storages 51 and 52 for storing various data such as the input image data described above. Among these, the data storage 51 is a part of the image inspection apparatus 50, and is used to temporarily store the reference data. In addition, the data storage 51 stores various data related to the image defect detected by the image inspection apparatus 50. In contrast, the data storage 52 is provided in the apparatus body (housing) of the image forming apparatus 20, and stores various data such as the use time of the component unit described above. The data storage 52 is connected to the controller 200 and the CPU of the image inspection apparatus 50 via an interface that is not shown. For the data storages 51 and 52, various data storage media such as hard disk drives (HDDs) and semiconductor memories can be used. Further, data to be stored may be shared between the data storage 51 of the image forming apparatus 20 and the data storage 52 of the image inspection apparatus 50.

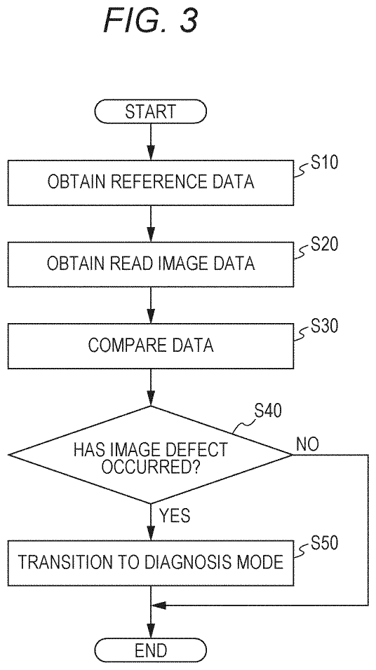

Next, the flow of processing of an inspection job performed by the image inspection apparatus 50 will be described with reference to the flowchart of FIG. 3.

In step S10, the image inspection apparatus 50 (the CPU of the image inspection apparatus 50 shown in FIG. 2, the same applies hereinafter) acquires the reference data described above in accordance with execution of a print job by the image forming apparatus 20. In the example shown in FIG. 2, the image inspection apparatus 50 receives reference data transmitted from the PC 60, and stores the received reference data in the data storage 51.

In step S20, the image inspection apparatus 50 acquires the read image data generated by the output image reader 31 of the image reading apparatus 30.

In step S30, the image inspection apparatus 50 compares the read image data acquired in step S20 with the corresponding reference data acquired in step S10 to inspect the identicalness between the reference image (correct image) and the read image.

In step S40, the image inspection apparatus 50 determines whether an image defect such as a streak has occurred in the image of the read image data. The processing of this determination varies depending on an item regarding the degree of match (type of defect of the read image) between the correct image and the read image, a reference value (threshold value) for pass/fail, and the like, and since these variations of the processing are the same as known methods, detailed description of the determination method will be omitted.

Here, when the image inspection apparatus 50 has determined that no defect (defective image) has occurred in the image of the read image data (step S40, NO), the image inspection apparatus determines that the image quality is at an acceptable level, and notifies the post-processing apparatus 40 to discharge the sheet S corresponding to the accepted read image data to a preset first tray (for example, the sheet discharge tray 42 of FIG. 1). Then, the image inspection apparatus 50 repeats the processing of steps S20 to S40 until the print job related to the inspection is completed, and ends the processing when the print job is completed. In this case, the image inspection apparatus 50 notifies the controller 200 of the image forming apparatus 20 that, for example, “the image quality has passed on all the printed pages”.

In contrast, when the image inspection apparatus 50 has determined that a defect (defective image) has occurred in the image of the read image data (step S40, YES), the image inspection apparatus 50 transitions to the diagnosis mode of diagnosing failure, malfunction, endurance, and the like of parts or the like of the image forming apparatus 20 after performing the following processing (step S50). The contents of processing in the diagnosis mode will be described later.

When the image inspection apparatus 50 has determined that a defect (defective image) has occurred in the image of the read image data (step S40, YES), the image inspection apparatus 50 transmits for example, a message such as “an image defect has occurred on the xxth printed page” to the controller 200 of the image forming apparatus 20. At this time, the image inspection apparatus 50 transmits the type of the image defect, the position of the image defect in the sheet S, and the like to the controller 200 of the image forming apparatus 20 together. In addition, the image inspection apparatus 50 notifies the post-processing apparatus 40 to discharge the sheet S corresponding to the rejected read image data onto a preset second tray (for example, the sheet discharge tray 43 of FIG. 1). Then, the image inspection apparatus 50 repeats the processing of steps S20 to S40 until the print job related to the inspection is completed, and transitions to step S50 when the print job is completed.

The post-processing apparatus 40 that has received the notification about the pass/fail of image quality from the image inspection apparatus 50 drives the switching gate of the sorter 41 to discharge the target sheet S to the corresponding sheet discharge tray (42 or 43). As another example, the image inspection apparatus 50 notifies the controller 200 of the image forming apparatus 20 of the acceptance or rejection of the image quality of the read image data, and the controller 200 may instruct the post-processing apparatus 40 about the discharge destination of the corresponding sheet S (which of the sheet discharge trays 42 and 43 is selected).

The image inspection apparatus 50 repeats the processing of step S20 to step S50 described above until the inspection job is completed, and in the case where the inspection job is finished (completed), transmits an inspection result to the image forming apparatus 20 and finish the inspection job normally. Typically, the image inspection apparatus 50 continuously executes the inspection job by repeatedly performing the processing of step S20 to step S40 described on all printed materials printed by execution of the print job by the image forming apparatus 20, and then finish the inspection job normally as described above.

Incidentally, in the image quality inspection system 1 as described above, when the image inspection apparatus 50 detects an image defect (image streak, density unevenness, density decrease, etc.) in the printed image (toner image), it becomes necessary to identify the cause of occurrence (in many cases, a mechanical defect in the image forming apparatus 20) of the image defect and perform maintenance of the identified machine (adjustment of a component unit of the image forming unit 21 or the like). Further, since each component unit of the image forming unit 21 has a life (lifetime), it is desirable to regularly diagnose the condition of the image forming apparatus 20 and predict the lifetime of the component unit separately from the execution of the inspection job described above.

Therefore, in the image quality inspection system 1 of the present embodiment, the processing of the diagnosis mode is performed by the following mechanism.

In general, in the present embodiment, generation modes (type, size, density, etc. of defects) of image defects that can occur due to a component unit of the image forming unit 21 are stored in advance in a storage medium (for example, the data storage 51 or 52, the same applies hereinafter) for each component unit. In the following description, a case where the generation mode (feature value) of an “image streak” whose factor as an image defect can be easily identified is stored in a storage medium for each component unit.

Further, in the present embodiment, prior to the execution of the diagnosis mode (step S50), data of usage history is stored and accumulated in a storage medium for each component unit of the image forming unit 21 which can be a generation factor of an image streak. Here, the “usage history” of component unit includes the amount of use (usage time, number of printed sheets, etc.) from the initial stage (or at the time of replacement) to the present, the number of replacements up to the present, the replacement timing, and the like.

Further, in the present embodiment, the image inspection apparatus 50 registers, for each component unit and in a storage medium, feature values (for example, “width” and “density”) of the image streak that can be generated due to the unit.

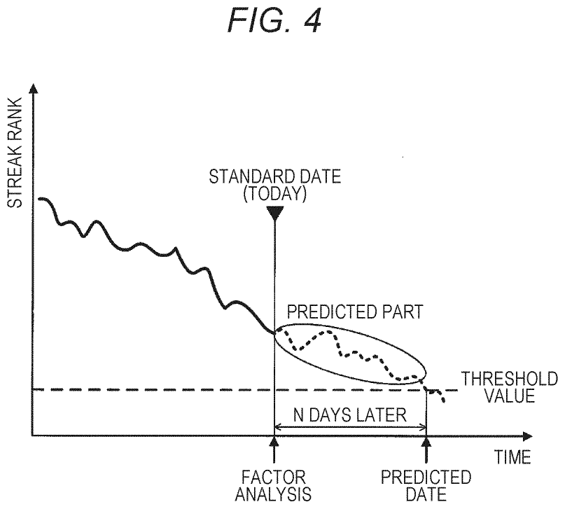

Further, in the present embodiment, the image inspection apparatus 50 generates, for each component unit, a prediction model for predicting a future change of an image defect (image streak in this example) generated with the component unit as a generation factor. Specific examples of such a prediction model will be described later with reference to FIG. 4.

Further, in the present embodiment, the presence or absence of the correlation between the component units is registered in a storage medium as a generation factor of the image streak. Specifically, when a plurality of component units (for example, a photosensitive unit and a transfer unit) cooperate to generate an image streak, these component units have a correlation. In contrast, when only one component unit serves as a factor for generating an image streak (for example, a band electrode unit) regardless of other component units, such a component unit has no correlation.

Next, an outline of the processing of the diagnosis mode in the present embodiment will be described. The processing of the following diagnosis mode may be performed not only in step S50, that is, not only when an image defect occurs in the inspection job, but also at a preset time cycle or at any time desired by the user.

First, the image forming apparatus 20 outputs an image (test chart) for diagnosis or test of image streaks and prints the image on a sheet S, causes the image reading apparatus 30 to read the image on the sheet S, and causes the image reading apparatus 30 to transmit the read image data to the image inspection apparatus 50.

The image inspection apparatus 50 that has acquired the image data performs processing as the image defect detector described above. Specifically, the image inspection apparatus 50 determines whether or not an image streak has occurred in the image of the test chart printed on sheet S, and if no image streak has occurred, outputs a diagnosis result that all component units of the image forming apparatus 20 are in a normal state. However, the criterion of this determination is set more strictly than the determination criterion of the inspection job (step S30) described above. Specifically, the image inspection apparatus 50 determines that an image streak has occurred on the test chart, even if the streak is a slight streak that the user can not recognize as an image defect.

When the image inspection apparatus 50 has determined that an image streak has occurred on the test chart, the image inspection apparatus 50 performs processing as the likelihood calculator described above. Specifically, the image inspection apparatus 50 detects the feature value of the detected image streak, and identifies the component unit of the image forming apparatus 20 serving as a generation factor of the image streak from the detected feature value. In addition, the image inspection apparatus 50 calculates the likelihood indicating the degree to which the identified component unit is correct as the generation factor of the image streak.

In one specific example, the image inspection apparatus 50 comprehensively take into consideration, as feature values of the image streak (hereinafter also simply referred to as a “streak), the width and density of the streak, the presence or absence of the periodicity of the streak, the degree of sharpness of the streak, and the like, and thus identifies the component unit serving as a generation factor of the streak. For example, when a plurality of image streaks are detected, and the cycle (generation interval) of the streaks is equal to the rotation cycle of the photosensitive drum of the photosensitive unit, the image inspection apparatus 50 can identify the photosensitive unit (photosensitive drum) as a generation factor and calculate the likelihood thereof as 100%.

Subsequently, the image inspection apparatus 50 performs the processing as the learning unit described above. That is, the image inspection apparatus 50 learns (or updates), by using the detected image streak as learning data, a prediction model for predicting a future change of the image streak generated with the identified component unit as a generation factor.

FIG. 4 is a chart showing an example of a prediction model learned and updated by the image inspection apparatus 50 (learning unit). In FIG. 4, the horizontal axis indicates the passage of time, and the vertical axis indicates a streak rank derived from a feature value of the image streak. This prediction model can be displayed on the display 26 of the image forming apparatus 20 as appropriate.

Here, a “streak rank” indicates the grade of the image streak. In one specific example, the “streak rank” is determined by ranking the degree of streaks according to the area (the depth of a two-dimensional profile) in which “width” and “density” of image streaks are multiplied, and the larger the area is, the lower the grade or the streak rank becomes. Generally, as the identified component unit approaches the end of endurance (life), the width or the density of the image streak generated from the component unit increases, and therefore the lower the streak rank is, the closer the streak rank is to a threshold value (see a straight line indicated by a dotted line in FIG. 4) indicating the endurance limit of the component unit.

The prediction model is generated and updated for each of the component units described above. Therefore, the threshold value described above may be set to a different value for each component unit.

Further, in FIG. 4, “STANDARD DATE (TODAY)” indicates the current date, that is, the date on which the prediction model of FIG. 4 is displayed by transitioning to the diagnosis mode, and “N days later” indicated by a double arrow indicates a remaining period estimated by the image inspection apparatus 50.

The image inspection apparatus 50 plots the value of the streak rank described above on the vertical axis of the “STANDARD DATE (TODAY)”, and also calculates the remaining period (value of N) of the component unit by machine learning using various data such as values of the streak rank specified in the diagnosis mode performed in the past (see the chart to the left of the standard date in FIG. 4), the use time of the component unit up to the present, and feature values of the current streak as parameters (learning data). That is, the image inspection apparatus 50 predicts by machine learning the future mode (the descending process) of the streak rank indicated by a broken curve in FIG. 4 and the number of days (value of N) until the streak rank reaches the threshold value. To be noted, various known machine learning techniques can be applied, and in one specific example, a neural network that processes information with a connectionismic computational technique is used.

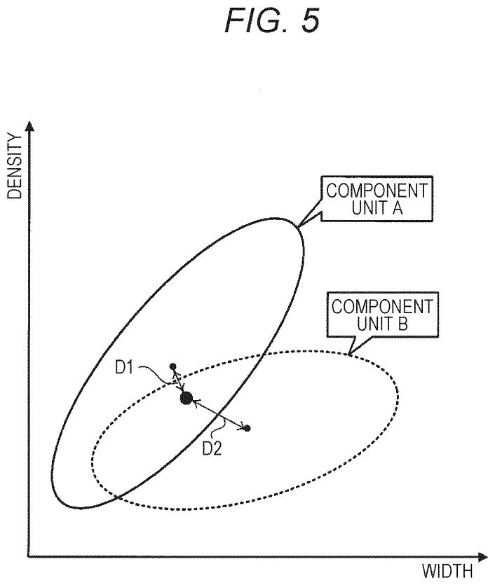

Incidentally, in the case of the diagnosis mode described above, a case where the image inspection apparatus 50 (likelihood calculator) can identify one component unit in the image forming apparatus 20 as a generation factor of the image streak and calculate the likelihood (certainty) as 100% has been assumed. However, in actuality, there may occur a case where a single component unit of the image forming apparatus 20 serving as a generation factor of the image streak cannot be always identified. This problem will be described below with reference to FIG. 5

FIG. 5 is a characteristic graph illustrating a relationship between examples of the feature value of the image streak and expression regions of component units serving as generation factors, the horizontal axis indicates the width of the image streak, and the vertical axis indicates the density of the image streak. As illustrated in FIG. 5, the range of feature values of an image streak (the expression region, that is, the region of width and density in an ellipse indicated by a solid line) generated due to one component unit A and the range of feature values of an image streak (the expression region of width and density in an ellipse indicated by a broken line) generated due to one component unit B do not match but partially overlap with each other. To be noted, the regions of the component units A and B in FIG. 5 can be set (stored in a storage medium) in advance based on measurement values of feature values of image streaks generated in the past, accumulation of the component units that have been factors, empirical rules, and the like. The following description will be made on the assumption that the component unit A is a band electrode unit (charging plate) and the component unit B is a photosensitive unit (photosensitive drum).

Here, when the feature values (width and density) of the image streak detected in the diagnosis mode is plotted in an expression region (hereinafter simply referred to as a region) belonging to only the component unit A (band electrode unit), the image inspection apparatus 50 can estimate that “the image streak has been caused by the component unit A (band electrode unit) with a likelihood of 100%”. Similarly, when the feature values of an image streak detected as a defective image is plotted in a region belonging to only the component unit B (photosensitive unit), the image inspection apparatus 50 can estimate that “the image streak has been caused by the component unit B (photosensitive unit) with a likelihood of 100%”.

Meanwhile, as illustrated in FIG. 5, there is a case where the feature values of the image streak detected in the diagnosis mode are plotted in an overlapping region of the component unit A and the component unit B. That is, there are three possible cases where the generation of image streaks is caused by only the component unit A, where the generation of image streak is caused by only the component unit B, and where the generation of image streak is caused by both the component unit A and the component unit B.

In this case, since there is no correlation in the component unit A (band electrode unit), the “case where the generation is caused by both the component unit A and the component unit B” can be excluded. On the other hand, in practice, there may be cases where the component unit A and the component unit B are correlated.

Then, in the diagnosis mode based on the conventional configuration, when there are a plurality of candidate component units serve as factors of defective images (image streaks) as described above, it is not possible to identify the component units, predict the lifetime, and the like with high precision. In other words, it can be said that, in the conventional diagnosis mode, diagnosis has not been performed in consideration of the “certainty” of the factors.

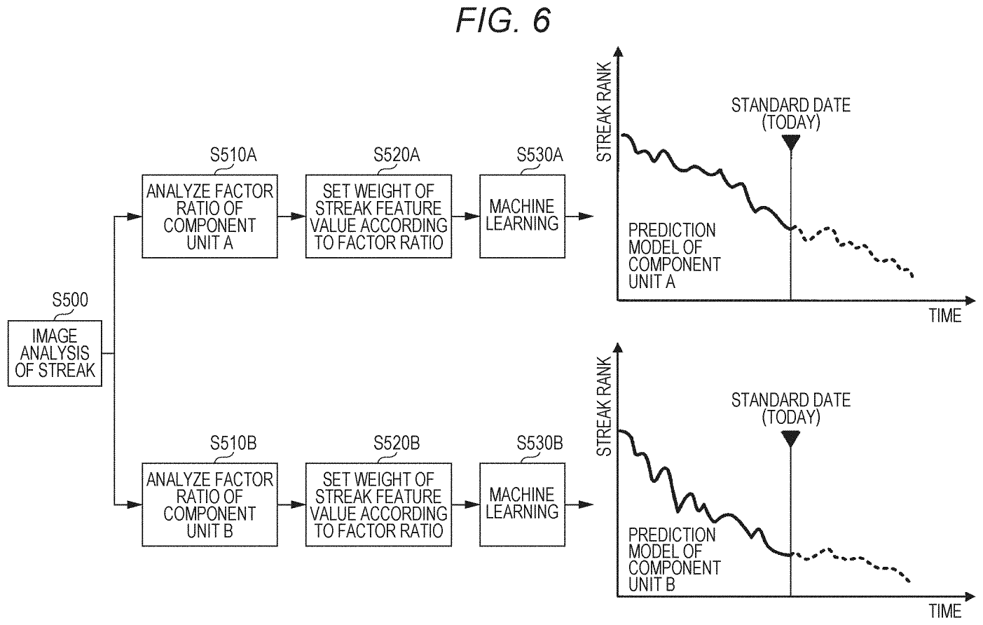

In view of the problems described above, in the present embodiment, the processing of the diagnosis mode is performed as follows. Hereinafter, with reference to FIG. 6, the processing of the diagnosis mode in the present embodiment will be described in more detail. Here, in FIG. 6, for the sake of clarity, a case where the two of the “component unit A (band electrode unit)” and the “component unit B (photosensitive unit)” in the image forming apparatus 20 are identified as generation factors of the image streak is shown. In addition, in some cases, three or more component units in the image forming apparatus 20 serving as generation factors of the image streak may be identified. The details of this will be described later.

In the present embodiment, in the diagnosis mode, the image inspection apparatus 50 (likelihood calculator) analyzes the image of the image streak to obtain feature values as described above, and identifies a component unit in the image forming apparatus 20 serving as a generation factor of the image streak (step S500).

Here, when there are a plurality of component units of the image forming apparatus 20 corresponding to the range (region) of the feature values of the image streak (see FIG. 5), the image inspection apparatus 50 (likelihood calculator) identifies the plurality of component units generation factors, and analyzes and determines the ratio of likelihood between these component units (hereinafter referred to as “factor ratio”) (step S510A and step S510B). Here, the factor ratio is determined in consideration of the certainty of the factor, and a specific determination method will be described later. In this example, the likelihood calculator assigns factor ratios such that the total factor ratio of the identified component units is 100%.

Subsequently, the image inspection apparatus 50 (learning unit) sets weights (in this example, the number of pieces of learning data) to feature values of the image streak specified in step S500 according to the assigned factor ratios (step S520A and step S520B).

The weight setting method is, for example, as follows. The image inspection apparatus 50 (learning unit) searches image streak data of the same result as the component units (in this example, “component unit A” and “component unit B”) determined in steps S510A and S510B and “factor ratio” from data (history) of the diagnosis mode performed in the past. In the following, it is assumed that the factor ratios determined in steps S510A and S510B are 60% for the component unit A and 40% for the component unit B.

For example, it is assumed that there are 30 pieces of data of image streaks detected in the diagnosis mode performed in the past, and there are 10 pieces of data of image streaks (streak feature values) for which the component unit A (band electrode unit) serves as a factor at a ratio of 60% and the component unit B (photosensitive unit) serves as a factor at a ratio of 40%.

In this case, the image inspection apparatus 50 (learning unit) applies 10×0.6=6 streak feature values to the learning data of a prediction model of the component unit A (band electrode unit) and 10×0.4=4 streak feature values to the learning data of a prediction model of the component unit B (photosensitive unit). The number of pieces of data to be reflected on the learning model is reduced in this manner, and thus the weight of the learning data (the number of applied pieces) is reduced.

Then, the image inspection apparatus 50 (predictor) uses the data of the set weight (the number of applied pieces) as parameters (learning data) of machine learning (for example, neural network) to learn or update the prediction model described above for each identified component unit, and thus lifetime prediction is performed for each component unit (in this example, the component units A and B) (steps S530A and S530B). As described above, by changing the weights (number of applied pieces) of learning data to be used for machine learning according to the likelihood (factor ratio), it is possible to cope with cases in which the generation factors of the image streak are apparently vague. As a result, according to the diagnosis mode of the present embodiment, the accuracy of the final prediction model can be improved (see the right side of the chart of FIG. 6).

Hereinafter, the method of assignment (allocation) of the factor ratios will be described. In the example shown in FIG. 5, the center point of each of the region of the component unit A and the region of the component unit B can be determined, and the factor ratios can be assigned with reference to which of the center points the position where the feature values (width and density) of the image streak are plotted is closer. Specifically, in the example shown in FIG. 5, the position where the feature values (width and density) of the image streak are plotted is closer to the center point of the region of the component unit A (distance D1), and in contrast, the position is farther from the center point of the region of the component unit B (distance D2 (D1<D2), close to a boundary position of the region in FIG. 4). In this case, the image inspection apparatus 50 (likelihood calculator) assigns a high factor ratio (for example, 80%) to the component unit A and assigns a low factor ratio (for example, 20%) to the component unit B.

Further, the image inspection apparatus 50 (likelihood calculator) can calculate the factor ratios based on the feature values of the image streak as described above, and also can appropriately correct calculated values of the factor ratios with reference to other various data such as the usage condition of the component units and the result of the diagnosis mode performed in the past. For example, when the image inspection apparatus 50 (likelihood calculator) estimates that the component unit B is unlikely to be a factor of the image streak due to, for example, no long time has passed after replacing the component unit B, the calculated values of the factor ratios are corrected to, for example, component unit A=100% and component unit B=0%. In this case, the image inspection apparatus 50 (learning unit) does not apply the streak feature value to the learning data of the prediction model of the component unit B, and applies 10×1.0=10 streak feature values as the learning data of the prediction unit A.

Further when the image inspection apparatus 50 (likelihood calculator) estimates that neither of the component units A and B is unlikely to be a factor of the image streak because, for example, no long time has passed after replacing either of the component units A and B, the calculated values of the factor ratios are corrected to, for example, component unit A=0% and component unit B=0%. In this case, the image inspection apparatus 50 (learning unit and predictor) does not apply the streak feature value to the learning data for the prediction model of both the component unit A and the component unit B.

The image inspection apparatus 50 (learning unit and predictor) uses learning data whose weight (the number of applied pieces) is to be reduced in the streak feature values for only learning of the streak rank dependent on the image, and applies the same learning data to learning of the use conditions (lifetime prediction) of the component units A and B at the original ratio (in this example, component unit A=80%, component unit B=20%) without reducing the weight (number of applied pieces).

Furthermore, a configuration may be employed in which, when the factor ratio calculated based on the feature values of the image streak and assigned to one component unit is smaller than a predetermined threshold value (for example, when the factor ratio of the component unit B is 10%), the image inspection apparatus 50 (learning unit and predictor) does not learn (update or the like) the prediction model of the component unit B, assuming that the possibility that the component unit B is a factor is extremely low. In this case, the image inspection apparatus 50 (likelihood calculator) redistributes the factor ratio to be assigned to the component unit A to 100%, and causes the predictor to learn (update) the prediction model of the component unit A. By performing such processing, for example, in a case where the position where the feature values (width and density) of the image streak is plotted is closer to the boundary position of the region of the component unit B, the accuracy of lifetime prediction of the component unit A considered to be a factor of the image streak can be improved.

In contrast, in a case where the factor ratios assigned to the component unit A and the component unit B having no correlation with each other by the likelihood calculator are both 50% or in a case close to this (for example, a case where the factor ratios are 49% and 51%), the image inspection apparatus 50 (learning unit and predictor) does not learn (update) each prediction model of the component units A and B, assuming that there is a high possibility of erroneous learning.

The case described above is a case where there are two component units that can be factors of the image streak and the two component units are a band electrode unit and a developing unit that are highly independent component units having no interaction with each other as generation factors of image streaks, and, as a whole, relatively simple cases have been described. However, in practice, a more complex case, specifically a case where there are three or more component units that can be identified as factors of the image streak, and the three or more component units include two or more component units having correlation (interaction) described above can occur.

Hereinafter, as such a case, a case where there are three component units that can be considered as factors of the image streak, and the third component unit (that is, a component unit C) is a transfer unit including an intermediate transfer belt that has correlation with the component unit B (photosensitive unit) described above is assumed.

When the image inspection apparatus 50 (likelihood calculator) has simultaneously specified three of the component unit A (band electrode unit), the component unit B (photosensitive unit), and the component unit C (transfer unit) as factors of the image streak, the learning data (streak feature values) is not applied to each prediction model of these, assuming that there is a high possibility of misclassification. Therefore, none of the prediction models of the component units A, B and C is learned (updated).

However, when the factor ratio of the component unit A (in this case, band electrode unit) having no correlation is higher than the factor ratios of the component units B and C (photosensitive unit and transfer unit) correlated with each other, the image inspection apparatus 50 (learning unit) applies the streak feature values to the learning data of the prediction model of the component unit A. That is, the image inspection apparatus 50 (learning unit) regards the component unit A as the generation factor of the image streak, reassigns the factor ratio of 100% to the component unit A, and causes the predictor to learn (update) the prediction model of the component unit A.

Alternatively, when the factor ratio of component unit A (band electrode unit) having no correlation exceeds a predetermined threshold value (for example, 80%), the image inspection apparatus 50 (learning unit) applies the streak feature values to the learning data of the prediction model of the component unit A to cause the predictor to learn (update) the prediction model of the component unit A. In this case, the threshold value (80%) described above may be appropriately changed or adjusted by the user through a user setting screen or the like that is not illustrated.

In addition, even when the component unit B and the component unit C having correlation are simultaneously determined as streak factors, if the factor ratios of these can be identified, the image inspection apparatus 50 (learning unit) applies the streak feature values to the learning data of each prediction model of the component units B and C. In this case, the image inspection apparatus 50 (learning unit) regards both of the component units B and C as generation factors of the image streak, reassigns the factor ratios to preset ratios such that the sum of the factor ratios assigned to the component units B and C is 100%, and thus causes the predictor to learn (update) the prediction models of the component units B and C.

As described above, the image inspection apparatus 50 (learning unit) changes how the learning data to be used for learning of each prediction model between a component unit having no correlation as a generation factor of the image streak (that is, highly independent) and a plurality of component units that are correlated (that is, that interact with each other), and thus the accuracy of learning by the predictor can be improved.

Flow of Processing in Diagnosis Mode

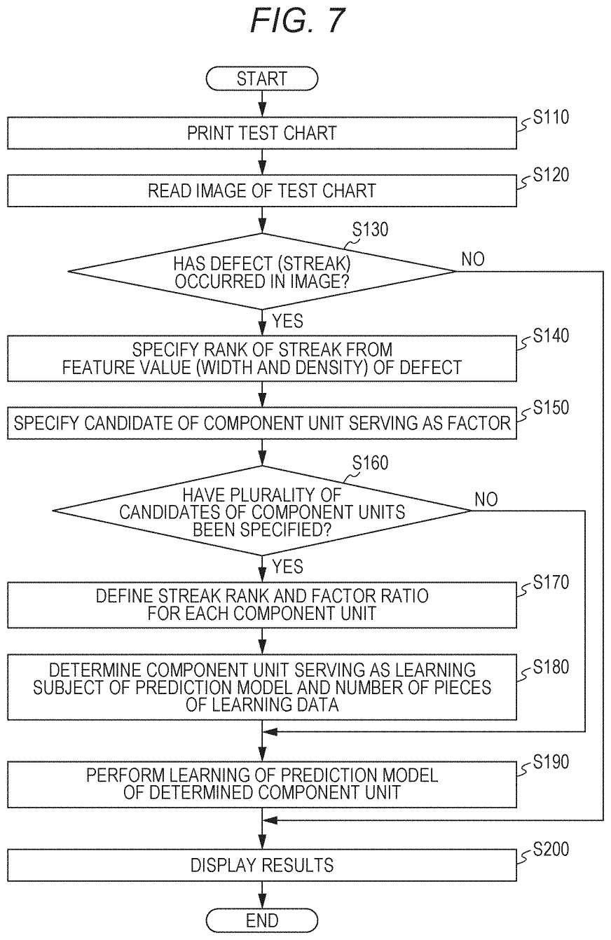

Next, the flow of processing in the diagnosis mode described above will be described with reference to the flowchart of FIG. 7. The processing shown in FIG. 7 can be performed regularly or at any time in addition to when a defective image is generated in step S40 of FIG. 3 described above.

In step S110 after the start of the diagnosis mode, the controller 200 of the image forming apparatus 20 controls each unit so as to print the test chart described above on the sheet S. The controller 200 also transmits reference data of the test chart to the image inspection apparatus 50. As the image of the test chart, a known design (for example, a mixture of vertical and horizontal bands) can be used, and the image may be printed on a plurality of (for example, three) sheets S.

In the subsequent step S120, the output image reader 31 reads the image of the test chart on the sheet S, and transmits the read image data to the image inspection apparatus 50.

Then, the image inspection apparatus 50 that has acquired the reference data of the test chart and the read image data inspect the identicalness between the reference image of the test chart and the read image by comparing these two pieces of data.

In step S130, the image inspection apparatus 50 (image defect detector) determines whether or not a defect (image streak herein) has occurred in the image of the read image data of the test chart. As described above, this determination is performed on a stricter criterion than the determination criterion of step S30 of the execution of the inspection job.

Here, when the image inspection apparatus 50 (image defect detector) has determined that no defect (image streak) has occurred in the image of the read image data (step S130, NO), the image inspection apparatus 50 transmits to the image forming apparatus 20 a message expressing that none of component units of the image forming apparatus 20 is malfunctioning. The controller 200 of the image forming apparatus 20 that has received such a message displays the received message on the display 26 (step S200), and finishes the processing of the diagnosis mode.

In contrast, when the image inspection apparatus 50 (image defect detector) has determined that a defect (image streak) has occurred in the image of the read image data (step S130, YES), the processing proceeds to step S140.

In step S140, the image inspection apparatus 50 (image defect detector) analyzes the content of the defect (image streak) to extract a feature value (such as the width and density of the streak), and specifies the defect rank (streak rank) corresponding to the extracted feature value. This specification can be performed using, for example, a reference table in which feature values of the image streak (in this example, individual values of the width and density of the streak) and the defect rank are associated.

Furthermore, the image inspection apparatus 50 (image defect detector) excludes, from the target, image streaks generated by foreign matter such as dust during analysis of the image streak. Specifically, since the image streaks generated by foreign matter such as dust has large sizes (width and length), the image inspection apparatus 50 (image defect detector) usually excludes image streaks of such large sizes from data to be input in the machine learning.

Subsequently, the image inspection apparatus 50 (likelihood calculator) identifies one or more candidate component units considered to be the cause of generation of the defect (image streak) from the specified defect rank (step S150). This specification can be performed using, for example, a reference table (see FIG. 5) in which each component unit of the image forming apparatus 20 and feature values of the image streak (in this example, individual values of the width and density of the streak) generated by each component unit are associated.

In the subsequent step S160, the image inspection apparatus 50 (likelihood calculator) determines whether or not there are a plurality of identified candidate component units.

Here, when the image inspection apparatus 50 (likelihood calculator) has determined that the number of identified candidate component units is one (step S160, NO), the processing of step S170 and step S180 is skipped on the assumption that the factor ratio (likelihood) of the component unit is 100%.

In contrast, when the image inspection apparatus 50 (likelihood calculator) has determined that there are a plurality of identified candidate component units (step S160, YES), the processing proceeds to step S170.

In step S170, the image inspection apparatus 50 (likelihood calculator) defines the rank of the defect (streak) and the factor ratio of each of the plurality of component units (candidates).

In step S180, the image inspection apparatus 50 (likelihood calculator) refers to the history of the diagnosis mode in the past, the usage history of each component unit identified in step S170, and the like, and appropriately adjusts the factor ratio defined in step S170. Then, according to the adjusted value, the image inspection apparatus 50 (likelihood calculator) determines the component unit whose prediction model is to be learned and the number of pieces of learning data of the prediction model (in this example, the number of feature values of image streaks to be applied).

In step S190, the image inspection apparatus 50 (learning unit) inputs the determined learning data to the predictor as parameters for machine learning, and causes the predictor to learn (update) the prediction model of the determined component unit. By this processing, (future) changes in image streaks generated with the component unit as a factor is predicted.

In the subsequent step S200, the image inspection apparatus 50 (predictor) displays a graph of the learned (updated) prediction model on the display 26 of the image forming apparatus 20 or the like (see FIG. 4 and FIG. 6), and thus inform the user of the days (value of N) until the life of the component unit reaches its end.

As described above, in the present embodiment, an image defect detector that detects an image defect (image streak) on a sheet S on which an image has been formed, a likelihood calculator that calculates a likelihood (certainty) that a component unit (image forming member) associated with the image formation is a generation factor of the image streak, a predictor that predicts a change in the image streak generated by the image forming member as a generation factor, and a learning unit that causes the predictor to perform learning using the detected image streak as learning data are provided, and the learning unit changes, according to the likelihood, a learning mode of the image streak to be used as the learning data.

More specifically, the image inspection apparatus 50 of the present embodiment identifies one or more component units in the image forming apparatus 20 serving as a generation factor of the image streak and the factor ratio (likelihood) thereof from the detected feature value of the image streak, learns the prediction model of each identified component unit for each component unit based on the feature value, and changes the ratio of application of the feature value to each prediction model based on the identified factor ratio.

According to the present embodiment which performs such processing, the prediction model of the component unit serving as a factor of the image streak is generated in a learning mode in consideration of the certainty of the generation factor of the image streak, and thus the accuracy of learning and the accuracy of lifetime prediction of the component unit can be improved.

Examples of Other Modifications

In the embodiment described above, a configuration example in which a prediction model is learned when an image streak occurs as an image defect has been described. The present embodiment is not limited to this, and a configuration in which the prediction model is learned when another defect or defective image (for example, density unevenness) occurs may be employed. On the other hand, an image streak has more feature values than other defective images, and has an advantage that the component unit serving as a factor is relatively easy to identify.

That is, in the embodiment described above, for the sake of simplicity, an example in which a two-dimensional parameter of width and density is used as an element of feature values of the image streak and the defect rank has been mainly described. On the other hand, in practice, more (N-dimensional) parameters such as the cycle, shape, degree of sharpness, and the like of the streak can be used as elements of the feature values of the image streak and the defect rank. For this reason, the component unit serving as a factor can be easily identified when using image streaks, as compared with other defects and defective images. In addition, even when the component unit has already reached the end of endurance (replacement timing) due to a failure or the like, the image streaks are likely to have distinctive feature values and the like.

In the embodiment described above, a configuration example in which the usage history of each component unit and the data of the result of the diagnosis mode performed in the past are used to perform machine learning of the prediction model in the diagnosis mode has been described. Further, in order to use more machine learning data in such machine learning, data on image defects (image streaks in the above example) acquired in the inspection job described above may be used.

In the embodiment described above, a case where one processor takes on each function of the image defect detector, the likelihood calculator, the predictor, and the learning unit has been described. As another example, these functions may be divided and performed by two or more processors. In addition, a processor, storage medium, and the like that perform learning and updating of a prediction model may be disposed at a remote location (for example, a server on a network).

In the embodiment described above, the configuration example in which the output image reader 31 is disposed outside the image forming apparatus 20 (at a subsequent stage of the fixing unit 22) has been described. As another example, the output image reader 31 may be provided inside the image forming apparatus 20, and may be disposed on the conveyance path between the image forming unit 21 and the fixing unit 22.

In the embodiment described above, a case of using the image forming apparatus 20 provided with the image forming unit 21 of the intermediate transfer system using electrophotographic process technology has been described. On the other hand, the system of image formation in the image forming apparatus 20 is not limited to such a system, and various other systems can be applied.

In addition, the embodiments described above are merely specific examples of practical forms of the present invention, and the technical scope of the present invention should not be interpreted to be limited thereto. That is, the present invention can be implemented in various forms without deviating from the summary or the primary features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. A learning apparatus comprising:
an image defect detector that detects an image defect on a sheet on which an image has been formed;
a likelihood calculator that calculates a likelihood that an image forming member associated with the image formation is a generation factor of the image defect;
a predictor that predicts a change in the image defect generated by the image forming member as a generation factor; and
a learning unit that causes the predictor to perform learning using the detected image defect as learning data,
wherein the learning unit changes, according to the likelihood, a learning mode of the image defect to be used as the learning data.

2. The learning apparatus according to claim 1,
wherein the predictor learns a prediction model representing change of the image defect in a future for each image forming member, and
the learning unit determines, according to the likelihood, the learning data to be used for learning of each prediction model.

3. The learning apparatus according to claim 2, wherein the learning unit determines, according to the likelihood, an amount of the learning data to be used for learning of each prediction model.

4. The learning apparatus according to claim 2, wherein the learning unit changes how the learning data to be used for learning of each prediction model is determined, between an image forming member having high independency as the generation factor and a plurality of image forming members having interaction with each other as the generation factor.

5. The learning apparatus according to claim 4, wherein the learning unit determines a preset ratio as the amount of the learning data to be used for each prediction model of the plurality of image forming members having interaction with each other.

6. The learning apparatus according to claim 4, wherein, in a case where a plurality of image forming members having high independency are identified as generation factors of the image defect by the likelihood calculator, the predictor does not perform learning of prediction models of the identified image forming members.

7. The learning apparatus according to claim 4, wherein, in a case where both of the image forming member having high independency and the plurality of image forming members having interaction with each other are identified as generation factors of the image defect and the likelihood of the image forming member having high independency is higher than the likelihood of the plurality of image forming members having interaction with each other, the learning unit causes the predictor to learn the prediction model of the image forming member having high independency by using the image defect as the learning data.

8. The learning apparatus according to claim 1, wherein the image defect is an image streak.

9. The learning apparatus according to claim 8,
wherein the image defect detector detects the image defect by excluding the image defect caused by a foreign matter from a result of reading an image on the sheet.

10. The learning apparatus according to claim 8,
wherein an expression region of a width and a density of the image streak having the image forming member as a generation factor is set for each image forming member, and
the likelihood calculator identifies the image forming member having the expression region to which the width and the density of the image streak detected by the image defect detector belongs as the generation factor of the image defect.

11. The learning apparatus according to claim 10, wherein, when the likelihood calculator has identified a plurality of image forming members, the likelihood calculator calculates the likelihood based on a distance from a center point of an expression region that each of the identified image forming members has.

12. A learning method comprising:
detecting an image defect on a sheet on which an image has been formed;
calculating a likelihood that an image forming member associated with the image formation is a generation factor of the image defect;
predicting, by using the detected image defect as learning data, a change in the image defect generated by the image forming member as a generation factor; and
changing according to the likelihood, a learning mode of the image defect to be used as the learning data.

13. A non-transitory recording medium storing a computer readable learning program causing a computer to perform:
detecting an image defect on a sheet on which an image has been formed;
calculating a likelihood that an image forming member associated with the image formation is a generation factor of the image defect;
predicting, by using the detected image defect as learning data, a change in the image defect generated by the image forming member as a generation factor; and
changing according to the likelihood, a learning mode of the image defect to be used as the learning data.
